(19) United States
(12) Patent Application Publication
(10) Pub. No.: US 2026/0251433 A1
(43) Pub. Date: Aug. 27, 2026

(54) Measurement Device with Graduated Markings and Light-Transmitting Slits

(71) Applicant: Jacek Guziczek, Rocky Hill, CT (US)

(72) Inventor: Jacek Guziczek, Rocky Hill, CT (US)

(21) Appl. No.: 19/354,599

(22) Filed: Oct. 9, 2025

Related U.S. Application Data
(60) Provisional application No. 63/763,347, filed on Feb. 26, 2025.

(51) Int. Cl. G01B 3/1084; G01B 3/1007; G01B 3/1056; G01B 3/1005

(52) U.S. Cl. CPC G01B 3/1084; G01B 3/1007; G01B 3/1056; G01B 2003/103; G01B 2003/1087

(57) ABSTRACT

A measurement device that functions as both a conventional tape measure and a laser-compatible measuring tool is disclosed. The device includes a housing that encloses a retractable spool carrying a flexible metallic tape blade with graduated markings corresponding to units of length. A locking mechanism secures the tape blade at a desired extension, and a protective transparent covering prevents wear and maintains visibility of the markings. A plurality of light-transmitting slits are disposed in the tape blade, each slit is aligned with at least one measurement marking and extends across the tape blade to permit a projected light beam (i.e., laser beam) to pass through. In use, the light beam illuminates the precise marking location, enabling accurate identification without awkward viewing angles. The invention provides a dual measurement system that increases accuracy, efficiency, and ergonomics, making it suitable for construction workers, contractors, tradespeople, and DIYers.

### CROSS-REFERENCE TO RELATED APPLICATION

The present application claims priority to, and the benefit of, U.S. Provisional Application No. 63/763,347 which was filed on February 26, 2025 and is incorporated herein by reference in its entirety.

### FIELD OF THE INVENTION

The present invention generally relates to measuring devices used in construction, carpentry, contracting, and do-it-yourself applications. More specifically, the present invention relates to a dual-mode tape measuring apparatus configured to function both as a conventional tape measure and as a laser-assisted measurement tool. The apparatus comprises a housing with a flexible metallic tape blade, the tape blade bearing graduated markings corresponding to units of length. A plurality of narrow slits are formed through the tape blade, each slit being aligned with a corresponding measurement marking and extending transversely across the blade. The slits permit a projected laser or light beam (i.e., illumination source) to pass therethrough at the precise location of the corresponding indicium, thereby providing a visible illuminated reference point. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals who work in construction, carpentry, contracting, and do-it-yourself projects often use laser levels or projected laser or light beam (i.e., illumination source)s to obtain precise linear references across a work surface. Such projection devices have become widely adopted because they provide a straight and highly visible reference line for alignment and measurement. However, such devices when used in conjunction with conventional tape measures present challenges in effective use.

A standard tape measure is formed of a solid metallic blade with continuous opaque markings. Because the blade is solid and non-transmissive, a projected laser or light beam (i.e., illumination source) cannot pass through the material. This prevents the user from visually correlating the exact point at which the laser line intersects a given measurement marking. As a result, individuals attempting to obtain accurate measurements must often crouch, bend, or even lie on the floor to align their eyes with the laser or light beam (i.e., illumination source) and the opaque tape surface. The conventional process is inefficient, ergonomically uncomfortable, and often unsanitary in real-world construction environments. Accordingly, individuals desire an improved tape measure device that can be easily used with a laser.

Therefore, there exists a long-felt need in the art for a measurement device that enables construction workers, contractors, tradespeople, and DIY users to take accurate measurements in conjunction with a projected laser or light beam (i.e., illumination source). There is a long-felt need in the art for a tape measure that eliminates the difficulty of aligning opaque blades with a laser line, thereby removing the need for crouching, kneeling, or lying on the floor to confirm accuracy. Additionally, there exists a need in the art for a measuring system that provides a dual mode of operation, functioning both as a conventional tape measure and as a laser-compatible tool. Furthermore, there is a need for a durable, portable, and ergonomically efficient device that improves measurement accuracy, increases workflow efficiency, and reduces physical strain for users working in diverse environments. Finally, there exists a need for a tape measurement device that includes slits running through the marked numbers for a laser or light beam (i.e., illumination source) to pass therethrough.

The subject matter disclosed and claimed herein, in one embodiment, comprises a measurement device including a housing enclosing a retractable spool configured to store a flexible metallic tape blade. The tape blade includes a plurality of graduated markings corresponding to linear units of length i.e., inches, centimeters, or millimeters. A protective transparent covering overlays the top surface of the tape blade to resist deformation and wear, while maintaining visibility of the graduated markings. A plurality of narrow slits are disposed and spaced along the length of the tape blade and each slit is aligned with a graduated marking. The slits extend transversely across opposite (i.e., opposing) longitudinal edges of the tape blade, enabling a projected laser or light beam (i.e., illumination source) to pass therethrough at the precise measurement location. A locking mechanism mounted on the housing secures the tape blade at a desired length during measurement operations.

In one embodiment, the housing of the measurement device is further equipped with a belt clip and a lanyard attachment point, enhancing portability and ease of use at construction sites. The lock tab disposed on the upper surface of the housing enables users to lock the extended length of the tape blade, thereby preventing unintended retraction. The free end of the tape blade includes a metal hook for pulling or anchoring against an edge of a workpiece.

In this manner, the measurement device of the present invention addresses longstanding deficiencies in the art by providing a dual-function system that combines the features of a conventional tape measure with laser-assisted precision. The device enhances workflow by reducing the time and effort required to confirm accurate measurements, improves ergonomic safety by eliminating the need for awkward body positions, and increases accuracy by aligning the laser or light beam (i.e., illumination source) directly with the measurement indicia. The system is compatible with common construction lasers and other linear illumination sources, and it may be manufactured from durable or disposable materials depending on use case.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a measurement device designed for use with a projected linear illumination beam. The device includes a durable housing, which may be formed from polymeric or metallic material, and within which a tape blade is coiled for selective extension through an opening. The tape blade has a top surface bearing graduated markings corresponding to units of measurement, as well as opposite (i.e., opposing) longitudinal edges across which narrow slits are formed. A locking tab is disposed on the housing to secure the tape blade at a chosen length. A protective transparent covering overlays the top surface of the blade to prevent deformation or wear while still enabling clear visibility of the markings. Each slit is aligned with at least one graduated marking, thereby permitting a laser or light beam (i.e., illumination source) projected perpendicularly to pass directly through the slit. The slit and the beam arrangement enable a user to view an illuminated measurement location without awkward positioning, enabling dual operation of the device both as a conventional tape measure and as a laser-compatible measuring tool.

In another embodiment, a method for measuring with a tape device comprising laser-transmitting or light-transmitting slits aligned with measurement markings is described. The method includes a user extending the tape blade from the housing and placing the tape blade across a desired work surface. The tape blade is then aligned with a projected linear laser or light beam (i.e., illumination source). As the laser or light beam (i.e., illumination source) intersects the blade, the beam passes through one of the narrow slits that correspond directly to a graduated marking. The user observes the point of illumination created at the intersection, which identifies the precise measurement location without requiring bending or awkward viewing angles. Finally, the user can mark or record the identified measurement on the work surface, providing both speed and accuracy during construction or layout tasks.

In one embodiment, a measurement system that integrates both a tape measuring device and a laser projection source is disclosed. The measuring device includes a housing from which a tape blade may be extended, wherein the tape blade bears conventional graduated markings along its surface. In addition, the tape blade is provided with a series of slits, each aligned with one of the measurement markings. The system further incorporates a laser projector that emits a linear beam across a work surface and perpendicularly to the tape blade. When the tape blade is placed within the path of the beam, the laser passes through one of the aligned slits, illuminating the exact location of a measurement marking.

In yet another embodiment, the housing further includes a belt clip for attachment to a tool belt or clothing, as well as a lanyard attachment point to facilitate carrying or securing the apparatus. The housing encloses a retractable spool, on which a flexible metallic tape blade is wound for selective extension.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of measurement device of the present invention in accordance with the disclosed structure;

FIG. 2 illustrates a perspective view of the measuring apparatus of the present invention in operation with a projected laser or light beam (i.e., illumination source) in accordance with the disclosed structure;

FIG. 3 illustrates a perspective view showing the measuring tape apparatus of the present invention in use during a marking operation in accordance with the disclosed structure;

FIG. 4 illustrates a flow chart depicting exemplary steps of the operational method of the measuring apparatus of the present invention, in accordance with the disclosed structure; and

FIG. 5 is a perspective view of the measuring apparatus of the present invention in a retracted state in accordance with an embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a measurement device that enables construction workers, contractors, tradespeople, and DIY users to take accurate measurements in conjunction with a projected laser or light beam (i.e., illumination source). There is a long-felt need in the art for a tape measure that eliminates the difficulty of aligning opaque blades with a laser line, thereby removing the need for crouching, kneeling, or lying on the floor to confirm accuracy. Additionally, there exists a need in the art for a measuring system that provides a dual mode of operation, functioning both as a conventional tape measure and as a laser-compatible tool. Furthermore, there is a need for a durable, portable, and ergonomically efficient device that improves measurement accuracy, increases workflow efficiency, and reduces physical strain for users working in diverse environments. Finally, there exists a need for a tape measurement device that includes slits running through the marked numbers for a laser or light beam (i.e., illumination source) to pass therethrough.

The present invention, in one exemplary embodiment, is a method for measuring with a tape device comprising laser-transmitting or light-transmitting slits aligned with measurement markings. The method includes a user extending the tape blade from the housing and placing the tape blade across a desired work surface. The tape blade is then aligned with a projected linear laser or light beam (i.e., illumination source). As the laser or light beam (i.e., illumination source) intersects the blade, the beam passes through one of the narrow slits that correspond directly to a graduated marking. The user observes the point of illumination created at the intersection, which identifies the precise measurement location without requiring bending or awkward viewing angles. Finally, the user can mark or record the identified measurement on the work surface, providing both speed and accuracy during construction or layout tasks.

Reference will now be made in detail to the present preferred embodiments of the invention, examples of which are illustrated in the accompanying drawings. Wherever possible, the same reference numerals are used in the drawings and the description to refer to the same or like parts.

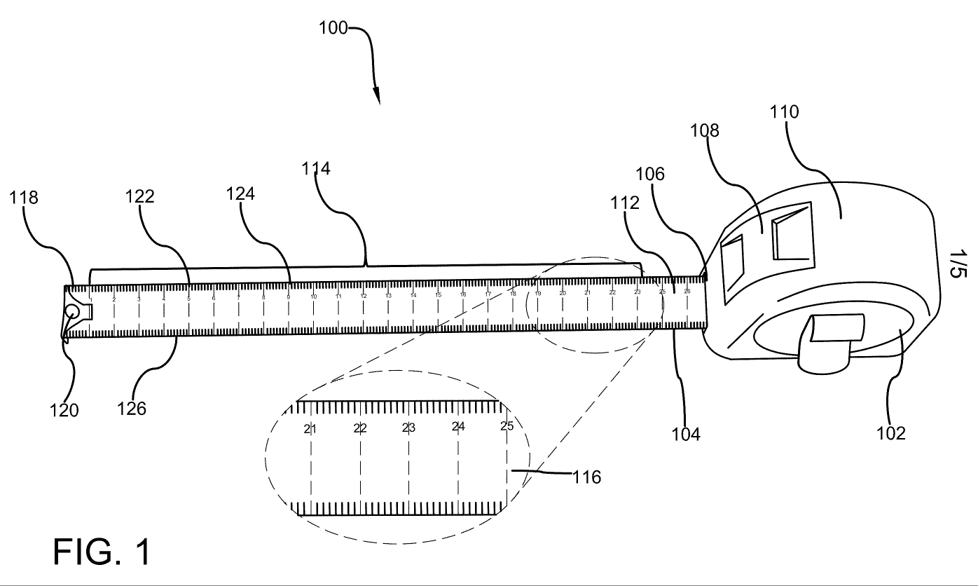

Referring initially to the drawings, FIG. 1 illustrates a perspective view of measurement device of the present invention in accordance with the disclosed structure. The measurement device 100 of the present invention is designed to enable construction workers, contractors, and DIYers to take accurate measurements against a laser or light beam (i.e., illumination source). The measurement device 100 a plurality of narrow slits through scale markings, enabling the laser or light beam (i.e., illumination source) to pass therethrough. More specifically, the measurement device 100 includes a housing 102 formed of durable polymeric or metallic material. A measuring tape blade 104 is configured to be coiled inside the housing 102 and is selectively extendable from an opening 106 disposed in the housing 102. The extended length of the measuring tape blade 104 can be locked to prevent further extension and retraction using a lock tab 108 disposed on the top end 110 of the housing 102.

The measuring tape blade 104 is preferably made of a flexible metallic strip and the top surface 112 of the measuring tape blade 104 has a plurality of graduated markings 114 corresponding to linear units of length. The graduated markings 114 correspond to linear units of length in different units i.e., inches, centimeters, millimeters, and other units as desired by users.

A protective transparent covering 116 overlay the top surface 112 of the measuring tape blade 104. The protective transparent covering 116 prevents the tape blade 104 from deformation and wearing, while enabling a user to view the graduated markings 114. The free end 118 of the measuring tape blade 104 has a hook 120 which can be used for pulling or extending the measuring tape blade 104 from the housing 102.

A plurality of laser-transmitting or light-transmitting slits or perforations 122 are disposed and spaced along length of the measuring tape blade 104. Each slit of the plurality of laser-transmitting or light-transmitting slits or perforations 122 is aligned with at least one graduated marking of the plurality of graduated markings 114. Each slit of the plurality of laser-transmitting or light-transmitting slits or perforations 122 extends across the opposite (i.e., opposing) longitudinal sides 124, 126 to enable laser or light beam (i.e., illumination source) projected perpendicularly across the tape blade 102 to pass through the slit. It should be noted that any linear illumination source i.e., LED can be used for operation with the slits or perforations 122.

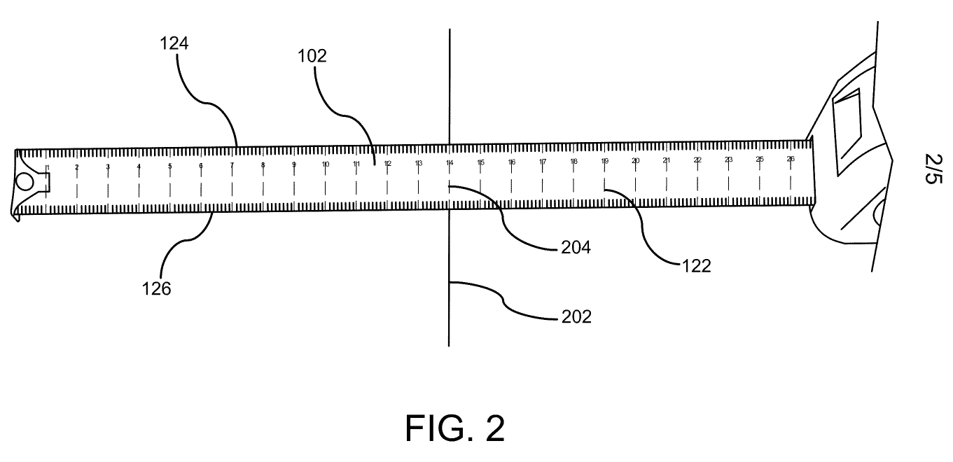

By passing or aligning the laser or light beam (i.e., illumination source) through a slit, an operator of the measurement device 100 can detect precise location of the graduated marking through which the laser light passes. The laser or light beam (i.e., illumination source) as illustrated in FIG. 2 enables accurate reading of the measurement without requiring the user to view the tape blade 104 from a low or inverted position.

The measurement device 100 provides a dual measurement system, enabling the measurement device 100 to function both as a conventional tape measure and as a laser-compatible measuring device. In a first mode of operation (i.e., first measuring element), the user may extend the tape blade 104 and read the graduated markings 114 directly in the same manner as a standard tape measure, providing reliable manual measurements without reliance on external devices. In a second mode of operation (i.e., second measuring element) as illustrated in FIG. 2, when a projected laser or light beam (i.e., illumination source) is present, the plurality of slits or perforations 122 disposed and spaced along the graduated markings 114 permit the laser to pass through at the precise location of the corresponding graduated markings 114, thereby converting the measurement tape device 100 into a laser-assisted measurement tool.

FIG. 2 illustrates a perspective view of the measuring apparatus of the present invention in operation with a projected laser or light beam (i.e., illumination source) in accordance with the disclosed structure. As described in FIG. 1, the tape blade 104 includes a plurality of laser-transmitting or light-transmitting slits or perforations 122 disposed and spaced along the length of the tape blade 104 wherein each slit corresponds to a graduated marking marked on the top surface of the tape blade 104. As illustrated, a laser or light beam (i.e., illumination source) 202 (i.e., projecting from a laser or any other similar illumination source) passes through the exemplary slit 204 (i.e., one of the plurality of slits or perforations) and across the opposite (i.e., opposing) edge 124, 126 of the tape blade 104, thereby enabling the user to visually confirm the measurement point (i.e., graduated marking) where the beam 202 passes through the tape blade 104. In use, the user may extend the tape blade 104 across a surface or workspace and align the tape blade 104 with the projected laser or light beam (i.e., illumination source) 202. As the laser or light beam (i.e., illumination source) 202 passes through the corresponding slit, the beam 202 makes the illuminated marking immediately visible. The configuration eliminates the need for the user to crouch, bend, or view the tape from an inverted angle, thereby improving accuracy, speed, and ergonomic efficiency.

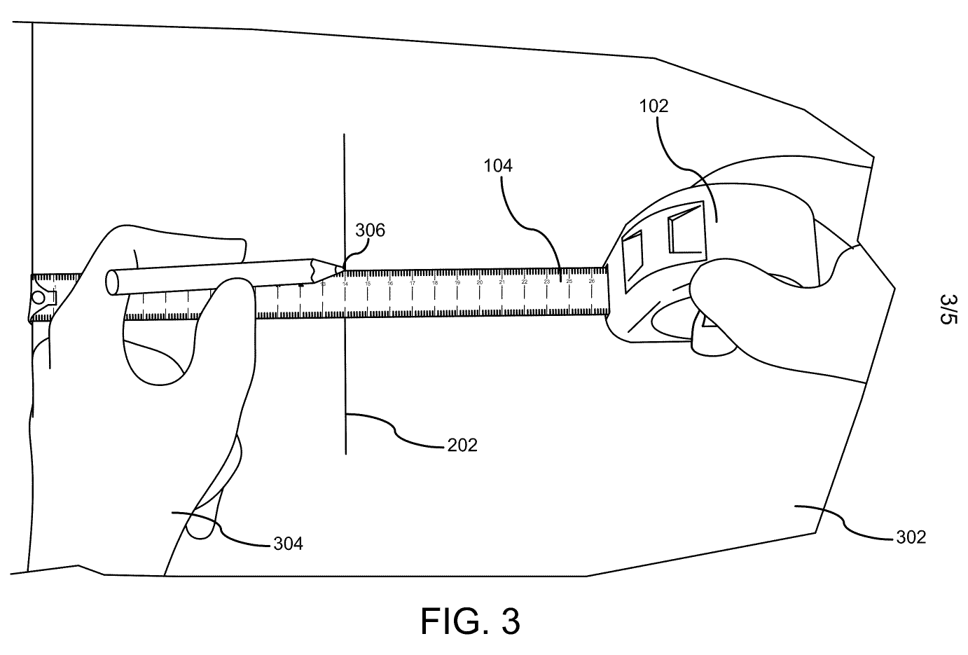

FIG. 3 illustrates a perspective view showing the measuring tape apparatus of the present invention in use during a marking operation in accordance with the disclosed structure. As illustrated, the tape blade 104 is extended from the housing 102 and is positioned against a vertical surface 302. Simultaneously, the projected laser or light beam (i.e., illumination source) 202 passes perpendicularly across the tape blade 104. As described earlier in the disclosure, the tape blade 104 includes the plurality of slits or perforations 122 (FIGS. 1 and 2) disposed and spaced along the length thereof and the laser or light beam (i.e., illumination source) 202 passes through at least one of the slits or perforations 122. Accordingly, a user 304 identifies the point of intersection 306 between the laser or light beam (i.e., illumination source) 202 and the tape blade 104 to mark the surface 302 at the location using a writing instrument.

The slits or perforations 122 provide a visual reference to the exact measurement aligned with the laser projection, enabling the user to make accurate markings on the work surface 302 without bending, kneeling, or misinterpreting the measurement scale.

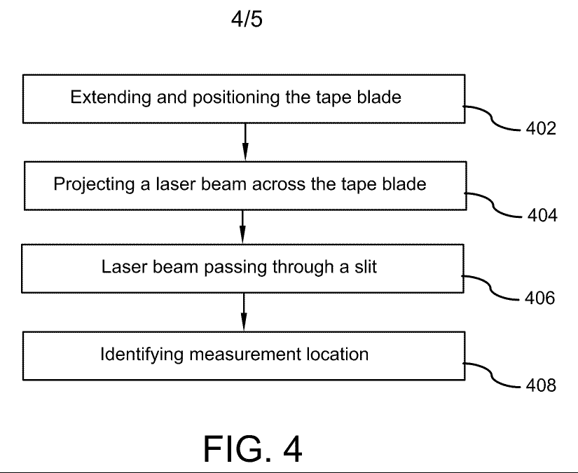

FIG. 4 illustrates a flow chart depicting exemplary steps of the operational method of the measuring apparatus of the present invention, in accordance with the disclosed structure. Initially, the tape blade 104 is extended outwardly from the housing 102 by the user and positioned across a desired work surface i.e., a wall, floor, or ceiling (Step 402). Once extended, the user orients the tape blade 104 such that the tape blade 104 lies within the path of a projected laser or light beam (i.e., illumination source), thereby achieving alignment between the tape and the laser (Step 404). As the laser or light beam (i.e., illumination source) intersects the tape blade, the beam passes through one of a plurality of slits disposed and spaced along the blade, each slit being positioned in direct correspondence with a graduated measurement marking printed on the surface of the tape (Step 406). The slit enables the laser to transmit visibly through the slit, producing an illuminated marking at the exact location of the measurement marking. The user is thereby able to immediately and accurately identify the correct measurement location without the need for crouching, kneeling, or viewing the tape from an inverted position (Step 408). At this point, the user may further mark the work surface with a writing instrument or record the measurement value for subsequent use, thereby completing the operation.

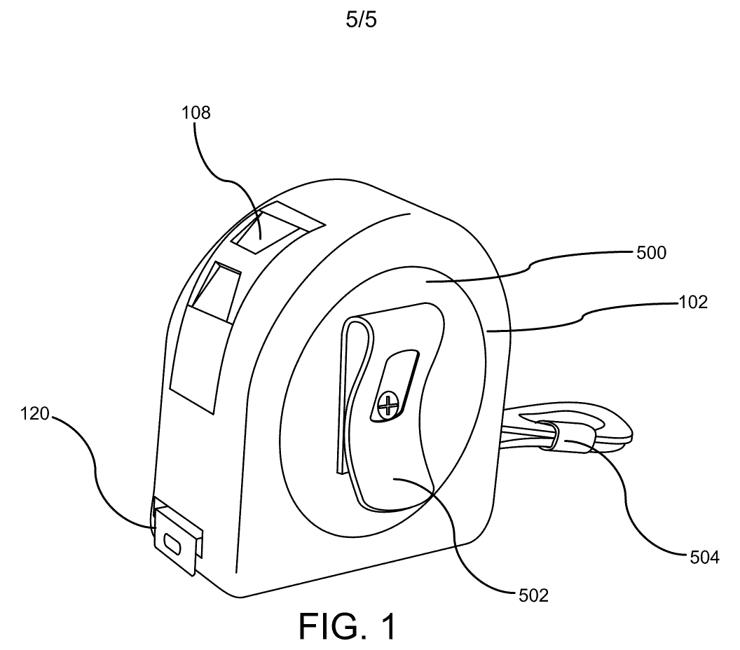

FIG. 5 is a perspective view of the measuring apparatus of the present invention in a retracted state in accordance with an embodiment of the present invention. The housing 102 is configured to enclose the tape blade 104 and retraction spool 500. A belt clip 502 is mounted to a side portion of the housing 102, enabling the apparatus 100 to be securely attached to a user’s clothing or tool belt for portability. The locking mechanism 108 is operable to selectively lock or release the tape blade 104 at a desired extended length. A strap or lanyard attachment 504 is further provided for ease of handling, storage, or securing the device to a wrist or anchor point. The structural configuration of the housing 102 provides durability, ergonomic handling, and portability for use in various construction, trade, or do-it-yourself applications.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “laser-transmitting or light-transmitting slits embedded tape measurement device”, “dual-mode tape measuring apparatus”, “measurement device”, and “apparatus” are interchangeable and refer to the laser-transmitting or light-transmitting slits embedded tape measurement device 100 of the present invention.

Notwithstanding the forgoing, the laser-transmitting or light-transmitting slits embedded tape measurement device 100 of the present invention can be of any suitable configuration as is known in the art without affecting the overall concept of the invention, provided that it accomplishes the above stated objectives. One of ordinary skill in the art will appreciate that the laser-transmitting or light-transmitting slits embedded tape measurement device 100 as shown in the FIGS. are for illustrative purposes only, and that many other configurations of the laser-transmitting or light-transmitting slits embedded tape measurement device 100 are well within the scope of the present disclosure. Although the dimensions of the laser-transmitting or light-transmitting slits embedded tape measurement device 100 are important design parameters for user convenience, the laser-transmitting or light-transmitting slits embedded tape measurement device 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A measurement device comprising:
a housing;
a measuring tape blade;
a first measuring element;
a second measuring element;
an illumination source; and
a lock tab;
wherein said measuring tape blade is configured to be coiled inside said housing;
wherein said housing comprising an opening for selectively extending said measuring tape blade therefrom;
wherein an extended length of said measuring tape blade is lockable to prevent further extension and retraction using said lock tab disposed on a top end of said housing;
wherein said measuring tape blade comprising a flexible metallic strip;
wherein said flexible metallic strip comprising a top surface;
wherein said first measuring element comprising a plurality of graduated markings corresponding to linear units of length;
wherein said top surface comprising a protective transparent covering overlaying said top surface;
wherein said measuring tape blade comprising a free end with a hook for pulling and extending said measuring tape blade from said housing; and
further wherein said second measuring element comprising a plurality of light-transmitting slits spaced along a length of said measuring tape blade.

2. The measurement device of claim 1, wherein each slit of said plurality of light-transmitting slits is aligned with at least one graduated marking of said plurality of graduated markings.

3. The measurement device of claim 1, wherein said each slit of said plurality of light-transmitting slits extends across opposing longitudinal sides of said measuring tape blade for said illumination source projected perpendicularly across said measuring tape blade to pass through at least one of said plurality of light-transmitting slits for indicating said second measuring element.

4. The measurement device of claim 1, wherein said illumination source is a laser light beam.

5. The measurement device of claim 1, wherein said illumination source is an LED.

6. The measurement device of claim 4, wherein said laser light beam is projected perpendicularly across said measuring tape blade to pass through one light-transmitting slit of said plurality of light-transmitting slits for indicating said second measuring element and is aligned with at least one graduated marking of said plurality of graduated markings for indicating said first measuring element.

7. The measurement device of claim 4, wherein said first measuring element is said measuring tape blade using said plurality of graduated markings and said second measuring element is a combination of said laser light beam and said plurality of light-transmitting slits.

8. A measurement device comprising:
a housing;
a measuring tape blade;
a first measuring element;
a second measuring element;
an illumination source; and
a lock tab;
wherein said measuring tape blade is configured to be coiled inside said housing;
wherein said housing comprising an opening for selectively extending said measuring tape blade therefrom;
wherein an extended length of said measuring tape blade is lockable to prevent further extension and retraction using said lock tab disposed on a top end of said housing;
wherein said measuring tape blade comprising a flexible metallic strip;
wherein said flexible metallic strip comprising a top surface;
wherein said first measuring element comprising a plurality of graduated markings corresponding to linear units of length;
wherein said top surface comprising a protective transparent covering overlaying said top surface;
wherein said measuring tape blade comprising a free end with a hook for pulling and extending said measuring tape blade from said housing;
wherein said second measuring element comprising a plurality of light-transmitting slits spaced along a length of said measuring tape blade; and
further wherein said illumination source is projected perpendicularly across said measuring tape blade to pass through one light-transmitting slit of said plurality of light-transmitting slits for indicating said second measuring element and is aligned with at least one graduated marking of said plurality of graduated markings for indicating said first measuring element.

9. The measurement device of claim 8, wherein each slit of said plurality of light-transmitting slits is aligned with at least one graduated marking of said plurality of graduated markings.

10. The measurement device of claim 8, wherein said each slit of said plurality of light-transmitting slits extends across opposing longitudinal sides of said measuring tape blade for said illumination source projected perpendicularly across said measuring tape blade to pass through at least one of said plurality of light-transmitting slits for indicating said second measuring element.

11. The measurement device of claim 8, wherein said illumination source is a laser light beam.

12. The measurement device of claim 8, wherein said illumination source is an LED.

13. The measurement device of claim 11, wherein said first measuring element is said measuring tape blade using said plurality of graduated markings and said second measuring element is a combination of said laser light beam and said plurality of light-transmitting slits.

14. A method of using a dual measurement device, the method comprising the steps of:
providing a housing, a measuring tape blade with a plurality of graduated markings, a first measuring element, a second measuring element, an illumination source, and a lock tab;
coiling said measuring tape blade inside said housing for storing said measuring tape blade, wherein said housing comprising an opening for selectively extending said measuring tape blade therefrom;
extending a length of said measuring tape blade outward from said housing across a work surface;
locking an extended said length of said measuring tape blade to prevent further extension and retraction using said lock tab disposed on a top end of said housing;
orienting and said measuring tape blade within a path of said illumination source; and
projecting said illumination source perpendicularly across said measuring tape blade to pass through one light-transmitting slit of a plurality of light-transmitting slits for indicating said second measuring element.

15. The method of using a dual measurement device of claim 14 further comprising a step of aligning said illumination source with at least one graduated marking of said plurality of graduated markings for indicating said first measuring element.

16. The method of using a dual measurement device of claim 14, wherein each slit of said plurality of light-transmitting slits is aligned with at least one graduated marking of said plurality of graduated markings.

17. The method of using a dual measurement device of claim 14, wherein said each slit of said plurality of light-transmitting slits extends across opposing longitudinal sides of said measuring tape blade for said illumination source projected perpendicularly across said measuring tape blade to pass through at least one of said plurality of light-transmitting slits for indicating said second measuring element.

18. The method of using a dual measurement device of claim 14, wherein said illumination source is a laser light beam.

19. The method of using a dual measurement device of claim 14, wherein said illumination source is an LED.

20. The method of using a dual measurement device of claim 18, wherein said first measuring element comprising said measuring tape blade using said plurality of graduated markings corresponding to linear units of length and, said second measuring element comprising said laser light beam and said plurality of light-transmitting slits spaced along a length of said measuring tape blade.
